(19) United States
(12) Patent Application Publication
(10) Pub. No.: US 2019/0069725 A1
(43) Pub. Date: Mar. 7, 2019

(54) Drink cup

(71) Applicants: Chih-Chin WANG, Taichung City (TW); Jo-Chi HUANG, Taichung City (TW); Chien-Liang HUANG, Taichung City (TW); Shih-Hung HSU, Kaohsiung City (TW)

(72) Inventors: Chih-Chin WANG, Taichung City (TW); Jo-Chi HUANG, Taichung City (TW); Chien-Liang HUANG, Taichung City (TW); Shih-Hung HSU, Kaohsiung City (TW)

(21) Appl. No.: 16/120,415

(22) Filed: Sep. 3, 2018

(30) Foreign Application Priority Data
Sep. 7, 2017 (TW) 106213279

(51) Int. Cl. A47J 43/07; A47J 43/046; B65D 51/28; B65D 43/02; A47G 19/22

(52) U.S. Cl. CPC A47J 43/0722; A47J 43/046; B65D 51/28; B65D 2543/00537; A47G 19/2205; B65D 2543/00092; B65D 43/0222

(57) ABSTRACT

A drink cup contains: a body, a cover, and a stirring unit. The body includes a bottom fringe, a peripheral fringe, a chamber, and an opening. The bottom fringe has an orifice defined on a central position thereof and communicating with the chamber. The stirring unit has a seat, a stirrer, and a fixing element, wherein the seat is mounted on the orifice and has a central hole communicating with the chamber. The stirrer has a stem, an outer diameter of which is less than the central hole, and the stirrer also has a blade and a first locking portion on a bottom of the stirrer. The fixing element has an engagement portion and a second locking portion. When the stem of the stirrer inserts through the central hole, the second locking portion of the fixing element is in connection with the first locking element of the stirrer so that the stem of the stirrer rotatably connects with the central hole of the seat.

### BACKGROUND OF THE INVENTION

### 1. Technical Field

The present invention relates to a cup, and more particularly to a drink cup which contains a stirrer configured to stir beverage by mating with a juicer.

### 2. Description of Related Art

Handmade drinks are popular in summer and are made of fresh vegetables and fruits so as to enhance consumers' health. But the handmade drinks have to be finished in a limited period of time (such as within one or two hours) so as to avoid oxidation and a loss of freshness. Accordingly, the handmade drinks are made in a sales site after consumers order them, thus limiting making efficiency of the handmade drinks.

Furthermore, a conventional drink cup is made of paper or plastic material, so various vegetables and the fruits are accommodated in a stir container of a juicer and they are stirred and mixed by the juicer so as to be poured into the drink cup. Thereafter, a cover or a seal film closes the drink cup and the drink cup is cleaned clearly, thus having complicated making process and long making time.

The present invention has arisen to mitigate and/or obviate the afore-described disadvantages.

### SUMMARY OF THE INVENTION

The primary aspect of the present invention is to provide a drink cup which is capable of accommodating and stirring vegetables and fruits immediately so as to sell fresh beverage to consumers quickly, thus avoiding cleaning a stir container.

Another aspect of the present invention is to provide a drink cup which is applicable for a vending machine, for example, after putting coins into the vending machine, the body in which the vegetables and the fruits are accommodated, drops out of the vending machine so that the cup drink is mounted on the drive portion of the vending machine so as to have the stirring process, thus obtaining fresh beverage immediately.

To obtain above-mentioned aspects, a drink cup provided by the present invention contains: a body, a cover, and a stirring unit.

The body includes a bottom fringe, a peripheral fringe surrounding the bottom fringe upwardly, a chamber defined beside the peripheral fringe, an opening formed on a top of the peripheral fringe, and an orifice defined on a center of the bottom fringe and communicating with the chamber.

The cover covers the opening of the body.

The stirring unit includes a seat, a stirrer, and a fixing element, wherein the seat is mounted on the orifice of the body and includes a central hole defined in a center thereof and communicating with the chamber, and the stirrer includes a stem, an outer diameter of which is less than the central hole, a blade fixed on a top of the stem, and a first locking portion formed on a bottom of the stem; wherein the fixing element includes an engagement portion formed on a bottom thereof and includes a second locking portion extending from a center of the engagement portion, when the stem of the stirrer inserts through the central hole, the second locking portion of the fixing element connects with the first locking portion of the stirrer so that the stem of the stirrer rotatably connects with the central hole of the seat.

Preferably, the body in which the vegetables and the fruits are accommodated, drops out of the vending machine so that the cover is removed to add various ingredients, such as sugars, milks, and ice cubes, etc. Thereafter, the cover covers the body and the cup drink is mounted on the drive portion of the vending machine so as to have the stirring process, thus obtaining fresh beverage immediately.

### BRIEF DESCRIPTION OF THE DRAWINGS

FIG. 1 is a perspective view showing the exploded components of a drink cup according to a preferred embodiment of the present invention.

FIG. 2 is a cross sectional view showing the assembly of the drink cup according to the preferred embodiment of the present invention.

FIG. 3 is a cross sectional view showing the assembly of a part of the drink cup according to the preferred embodiment of the present invention.

FIG. 4 is a top plan view showing the assembly of a part of the drink cup according to the preferred embodiment of the present invention.

FIG. 5 is another cross sectional view showing the assembly of a part of the drink cup according to the preferred embodiment of the present invention.

FIG. 6 is another top plan view showing the assembly of a part of the drink cup according to the preferred embodiment of the present invention.

FIG. 7 is a bottom plan view showing the assembly of a part of the drink cup according to the preferred embodiment of the present invention.

FIG. 8 is a cross sectional view showing the application of the drink cup according to the preferred embodiment of the present invention.

### DETAILED DESCRIPTION OF THE PREFERRED EMBODIMENTS

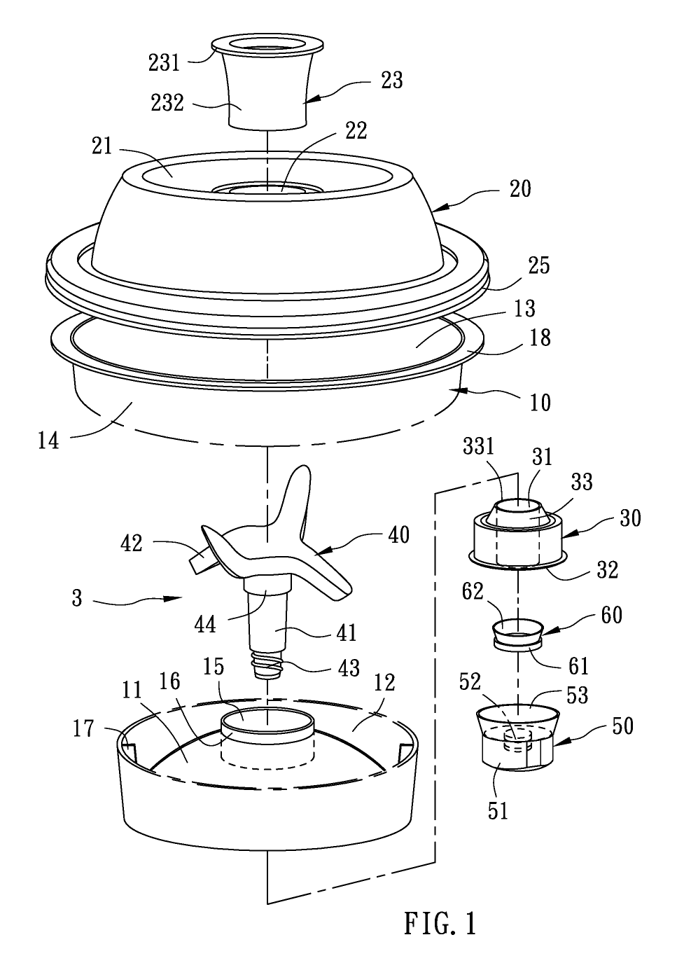

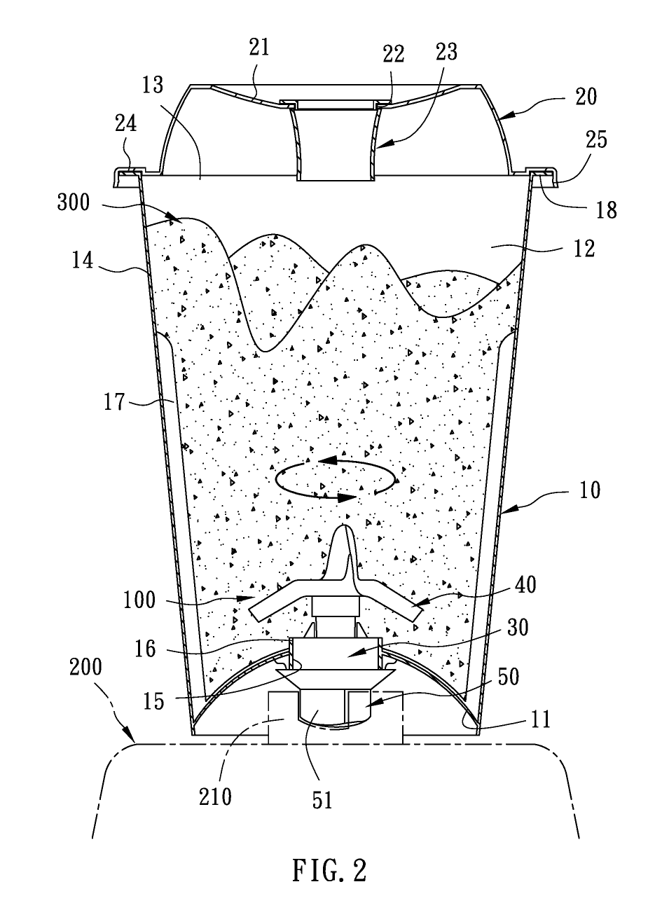

With reference to FIGS. 1 and 2, a drink cup according to a preferred embodiment of the present invention comprises: a body 10, a cover 20, and a stirring unit 3.

The body 10 includes a bottom fringe 11, a peripheral fringe 14 surrounding the bottom fringe 11 upwardly, a chamber 12 defined beside the peripheral fringe 14, an opening 13 formed on a top of the peripheral fringe 14, and an orifice 15 defined on a center of the bottom fringe 11 and communicating with the chamber 12. In this embodiment, the bottom fringe 11 of the body 10 is in a drum shape and has a column 16 extending upward from the center of the bottom fringe 11, wherein the orifice 15 is defined in the column 16. The peripheral fringe 14 of the body 10 has multiple wings 17 extending outwardly from an inner surface of the peripheral fringe 14, hence the multiple wings 17 facilitate stirring of beverage.

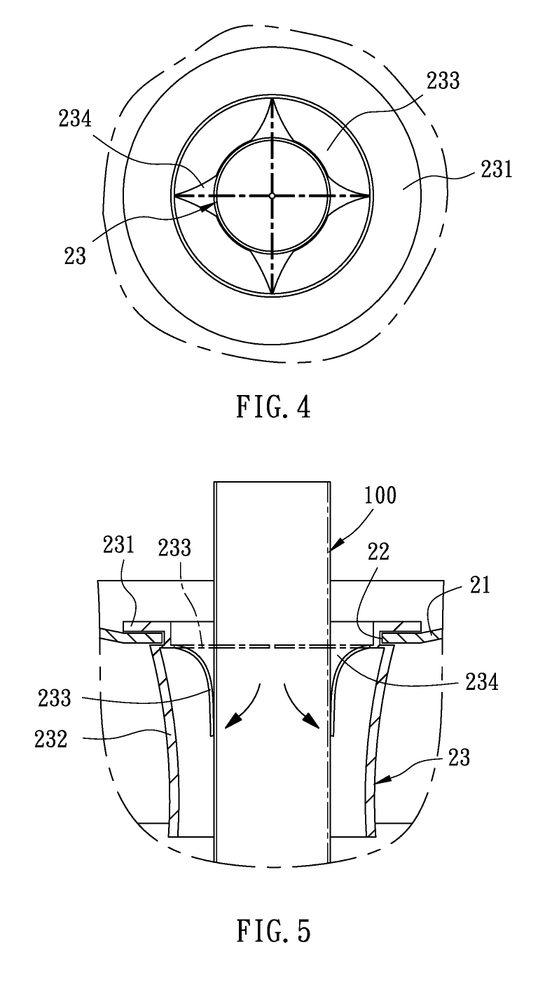

The cover 20 covers the opening 13 of the body 10, and the cover 20 includes a through hole 22 defined on a center of the top fringe 21 and a holder 23 removably connected on the through hole 22. Referring to FIGS. 4 and 5, the holder 23 is made of flexible plastic and includes a first surround rib 231, a tubular section 232 extending outwardly from the surround tab 231, a connection sheet 233 defined between the surround tab 231 and the tubular section 232, and a cross hole 234 passing through the connection sheet 233, wherein the tubular section 232 of the holder 23 extends into the through hole 22 so that the surround tab 231 retains on the through hole 22 and a straw 100 inserts into the holder 23. When the straw 100 forces the connection sheet 233 to insert into the cross hole 234, the connection sheet 233 stretches outwardly, and the cross hole 234 expends and retains the straw 100, thus drinking the beverage by using the straw 100.

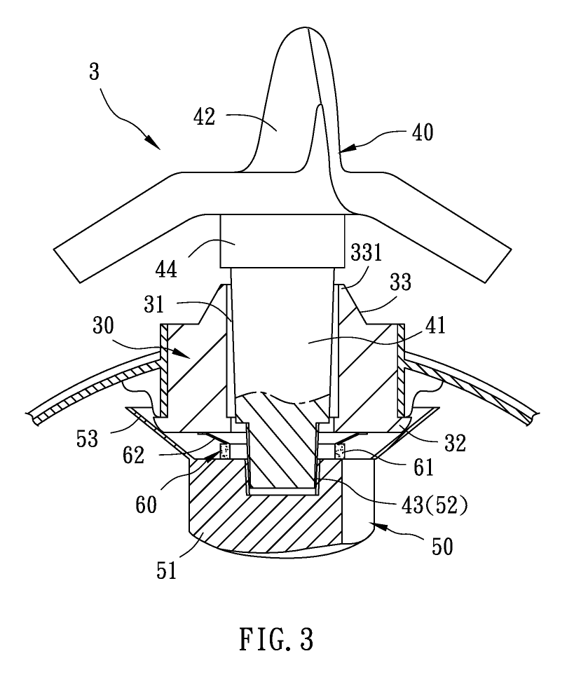

As shown in FIG. 2, the body 10 further includes a second surround rib 18 arranged around the opening 13, and the cover 20 includes a groove 24 formed on an outer wall of a bottom thereof and includes a peripheral tab 25 located below the groove 24, hence the peripheral tab 25 of the cover 20 is forced into the body 10 so that the second surround rib 18 retains in the groove 24 of the cover 20, thus covering the cover 20 on the body 10. Referring further to FIGS. 1 and 3, the stirring unit 3 includes a seat 30, a stirrer 40, and a fixing element 50. The seat 30 is mounted on the orifice 15 of the body 10 and includes a central hole 31 defined in a center of the seat 30 and communicating with the chamber 12. The stirrer 40 includes a stem 41, an outer diameter of which is less than the central hole 31, a blade 42 fixed on a top of the stem 41, and a first locking portion 43 formed on a bottom of the stem 41. The fixing element 50 includes an engagement portion 51 formed on a bottom thereof, a second locking portion 52 extending from a center of the engagement portion 51, and a flap 53 obliquely extending outward from an outer wall of a top of the engagement portion 51. As illustrated in FIG. 7, the engagement portion 51 is triangular. When the stem 41 of the stirrer 40 inserts through the central hole 31, the second locking portion 52 of the fixing element 50 connects with the first locking portion 43 of the stirrer 40 so that the stem 41 of the stirrer 40 rotatably connects with the central hole 31 of the seat 30.

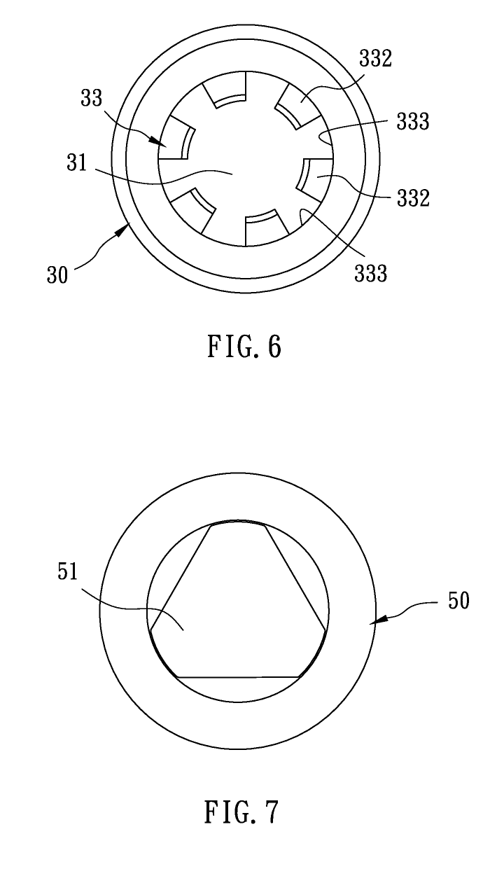

A stepped portion 43 is defined between the stem 41 and the blade 42 of the stirrer 40, and an outer diameter of the stepped portion 44 is more than that of the central hole 31 of the seat 30 so that the stepped portion 44 is limited above the central hole 31. The seat 30 further includes a first stop portion 32 retained on a bottom of the orifice 15 and includes a second stop portion 33 extending outside a top of the central hole 31. In this embodiment, the second stop portion 33 is in a circular ring shape and a longitudinal cross section of the second stop portion 33 is conical, wherein a top of the second stop portion 33 abuts against the stepped portion 44 of the stem 41 so as to limit the stirrer 40. With reference to FIG. 6, the second stop portion 33 of the seat 30 has multiple conical extensions 332 equidistantly arranged around the central hole 31 and has multiple voids 333 defined among the multiple conical extensions 332 respectively so as to reduce a contact area with the stem 41, thus decreasing a rotation resistance of the stirrer 40 and saving manufacture materials. Referring to FIGS. 1 and 3, the stirring unit 3 further includes a fitting element 60 abutting against a bottom of the seat 30 and a top of the fixing element 50, and the fitting element 60 is fitted on the stem 41 of the stirrer 40 so as to obtain anti-leakage effect. The fitting element 60 is a flexible sleeve and includes a bottom fence 61 and an extending fence 62 obliquely extending outward from the bottom fence 61, when the stirrer 40 locks with the fixing element 50, the stirrer 40 and the fixing element 50 force the flexible element 60 inwardly.

When a user makes juices, vegetables and fruits are placed into the chamber 12 of the body 10, and the cover 20 covers the drink cup, then the body 10 is fixed on a juicer, as shown in FIGS. 2 and 3, wherein the engagement portion 51 of the fixing element 50 engages on a drive portion 210 of the juicer 200, thus having a stirring process.

When the fixing element 50 is driven by the drive portion 210 to rotate, the stirrer 40 is actuated simultaneously to rotate in the central hole 31 of the seat 30, in the meantime, the blade 42 of the stirrer 40 cuts, stirs, and mixes the vegetables and the fruits together. Preferably, the multiple wings 17 facilitate the stirrer 40 of the vegetables and the fruits in the stirring process so as to make fresh beverage 300 quickly. After the stirring process, the body 10 having the beverage 300 is removed from the juicer 200 easily.

Thereby, the drink cup of the present invention accommodates and stirs the vegetables and the fruits so as to make the beverage easily and quickly and to maintain hygiene and freshness of the beverage.

It is to be noted that the drink cup of the present invention is applicable for a vending machine, for example, after putting coins into the vending machine, the body 10 in which the vegetables and the fruits are accommodated, drops out of the vending machine so that the cover 20 is removed to add various ingredients, such as sugars, milks, and ice cubes, etc. Thereafter, the cover 20 covers the body 10 and the cup drink is mounted on the drive portion 210 (as shown in FIG. 2) of the vending machine so as to have the stirring process, thus obtaining fresh beverage immediately.

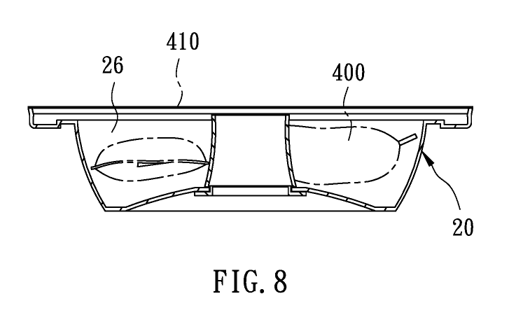

Referring to FIG. 8, the cover 20 includes a receiving room 26 defined therein so as to accommodate an ingredient bag 400 in which sugars, creamers, cookies, tapioca balls, pulps, and/or ice cubes are accommodated. Thereafter, a seal film 410 closes the cover 20 in which the ingredient bag 400 is housed.

The engagement portion 51 of the fixing element 50 corresponds to a profile of the drive portion 210 of the juicer 200, for example, the profile of the drive portion 210 is in any one of a rectangle shape, a triangle shape, and a cone shape.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A drink cup comprising:
a body including a bottom fringe, a peripheral fringe surrounding the bottom fringe upwardly, a chamber defined beside the peripheral fringe, an opening formed on a top of the peripheral fringe, and an orifice defined on a center of the bottom fringe and communicating with the chamber;
a cover covering the opening of the body; and
a stirring unit including a seat, a stirrer, and a fixing element, wherein the seat is mounted on the orifice of the body and includes a central hole defined in a center thereof and communicating with the chamber, and the stirrer includes a stem, an outer diameter of which is less than the central hole, a blade fixed on a top of the stem, and a first locking portion formed on a bottom of the stem; wherein the fixing element includes an engagement portion formed on a bottom thereof and includes a second locking portion extending from a center of the engagement portion, when the stem of the stirrer inserts through the central hole, the second locking portion of the fixing element connects with the first locking portion of the stirrer so that the stem of the stirrer rotatably connects with the central hole of the seat.

2. The drink cup as claimed in claim 1, wherein the stirring unit further includes a fitting element abutting against a bottom of the seat and a top of the fixing element, and the fitting element is fitted on the stem of the stirrer, wherein the fitting element is a flexible sleeve and includes a bottom fence and an extending fence obliquely extending outward from the bottom fence.

3. The drink cup as claimed in claim 1, wherein the cover includes a through hole defined on a center of the top fringe and a holder removably connected on the through hole, the holder is made of flexible plastic and includes a first surround rib, a tubular section extending outwardly from the surround tab, a connection sheet defined between the surround tab and the tubular section, and a cross hole passing through the connection sheet, wherein the tubular section of the holder extends into the through hole so that the surround tab retains on the through hole.

4. The drink cup as claimed in claim 1, wherein the seat of the stirring unit further includes a first stop portion retained on a bottom of the orifice.

5. The drink cup as claimed in claim 1, wherein a stepped portion is defined between the stem and the blade of the stirrer, and an outer diameter of the stepped portion is more than that of the central hole of the seat so that the stepped portion is limited above the central hole, wherein the seat further includes a second stop portion extending outside a top of the central hole, and a longitudinal cross section of the second stop portion is conical, wherein a top of the second stop portion abuts against the stepped portion of the stem.

6. The drink cup as claimed in claim 5, wherein the second stop portion is in a circular ring shape.

7. The drink cup as claimed in claim 5, wherein the second stop portion of the seat has multiple conical extensions equidistantly arranged around the central hole.

8. The drink cup as claimed in claim 1, wherein the body further includes a second surround rib arranged around the opening, and the cover includes a groove formed on an outer wall of a bottom thereof so that the second surround rib retains in the groove of the cover, and the cover covers on the body, wherein the cover further includes a receiving room defined therein so as to accommodate an ingredient bag, and a seal film closes the receiving room of the cover.

9. The drink cup as claimed in claim 1, wherein the fixing element includes a flap obliquely extending outward from an outer wall of a top of the engagement portion.

10. The drink cup as claimed in claim 1, wherein the peripheral fringe of the body has multiple wings extending outwardly from an inner surface of the peripheral fringe, and the bottom fringe of the body is in a drum shape and has a column extending upward from the center of the bottom fringe, wherein the orifice is defined in the column.
